(19) United States
(12) Patent Application Publication
(10) Pub. No.: US 2026/0061429 A1
(43) Pub. Date: Mar. 5, 2026

(54) Crushing device for comminuting mineral material

(71) Applicant: Kleemann GmbH, Göppingen (DE)

(72) Inventors: Sebastian Grot, Holzmaden (DE); Steffen Häberle, Herbrechtingen (DE); Till Krauss, Rechberghausen (DE); Jochen Meier, Hülben (DE)

(21) Appl. No.: 19/289,200

(22) Filed: Aug. 4, 2025

(30) Foreign Application Priority Data
Sep. 4, 2024 (DE) 10 2024 125 360.6

(51) Int. Cl. B02C 25/00; B02C 13/28; B02C 21/02

(52) U.S. Cl. CPC B02C 25/00; B02C 13/2804; B02C 21/026; B02C 2210/01

(57) ABSTRACT

A crushing device includes a crushing chamber. A comminution device is accommodated in the crushing chamber. The comminution device bears at least one comminution tool. The crushing chamber is delimited by at least one crushing chamber boundary. The crushing chamber boundary has an inner face facing the crushing chamber and an outer face facing away from the crushing chamber. The crushing chamber boundary has an inspection opening. A detection device is held by a mounting to be provided for determining the wear condition of the communition tool in the crushing chamber. The detection device may be moved between a park position and a detection position through the inspection opening preferably by means of an actuator, wherein the detection device is arranged in the detection position at least sectionally inside the crushing chamber and is arranged outside of the crushing chamber in the park position.

### RELATED APPLICATIONS

The present application claims priority to German Patent Appl. Ser. No. DE 10 2024 125 360.6 filed Sept. 4, 2024, which is incorporated herein by reference.

### BACKGROUND OF THE DISCLOSURE

### Field of the Disclosure

The disclosure relates to a crushing device for crushing mineral material or the like, having a crusher unit, which has a crushing chamber, wherein a comminution device is accommodated in the crushing chamber, in particular movably, preferably rotatably or in a swiveling manner, wherein the comminution device bears or has at least one comminution tool, in particular a crushing tool, wherein the crushing chamber is delimited by at least one crushing chamber boundary, wherein the crushing chamber boundary has an inner face facing the crushing chamber and an outer face facing away from the crushing chamber, and wherein the crushing chamber boundary has an inspection opening.

Crushing devices according to the disclosure can, for instance, be designed such that they have a rotor as the comminution device, which rotor is held rotatably in the crushing chamber. Such a crushing device can therefore be an impact crusher, a cone crusher or a gyratory crusher. Alternatively, it can also be a comminution device, in which the comminution device has a crushing body disposed in the crushing chamber in a swiveling manner. Such crushing devices can be jaw crushers, for instance.

The crushing tool can be an exchangeable tool that is interchangeably connected to the comminution tool, for instance. In particular, the crushing tool can be an impact bar, an impact rocker, a crusher spindle, a crusher roll or a crushing jaw.

In the context of the disclosure, the crushing tool does not necessarily have to be part of the movable part (for instance, the rotor or the swiveling crushing body) of the comminution tool. Rather, in the context of the disclosure, the crushing tool can be a part that is disposed in the crushing chamber at least sectionally, for instance an impact rocker or a crushing chamber lining, in particular also a part of the crushing chamber boundary.

### Description of the Prior Art

The crushing chamber of generic crushing devices, in particular rock comminution machines, is very difficult to access due to the nature of the system. The safety measures required to access the crushing chamber render accessibility even more difficult. Regularly checks of the wear parts in the crushing chamber is therefore very time-consuming. To this end, sensor-based wear measurements offer an enormous advantage, both in terms of operator safety and machine downtime. In addition to a pure wear measurement, which enables the operator to plan the adjustment of the crushing gap as wear progresses and the stockpiling of wear parts and their installation, such a system can detect damage in good time and prevent major machine damage. In addition, sensor-based wear measurements offer significant advantages in terms of measurement accuracy compared to the visual evaluation by the machine operator that is common today.

Solutions are known from the state of the art, in which wear parts of a comminution tool consist of a cast material. The measuring system of the detection device is built directly into the cast part. In cast parts, this can only be achieved at great expense. When the wear part is replaced, the detection device is also replaced, which requires a large number of parts.

Methods that use ultrasound to determine the layer thickness of wear parts are also known (see DE 2357432 B2 (U.S. Pat. No. 3,944,146)). Ultrasonic sensors that are used to determine coating thickness usually use a sensor head that is attached directly to the wear part. The sound waves would otherwise be reflected or refracted when the medium changes (e.g. air to steel). Such a sensor arrangement is also impractical.

### SUMMARY OF THE DISCLOSURE

The disclosure addresses the problem of providing a crushing device of the type mentioned at the beginning, which renders a safe and reliable wear detection possible.

This problem is solved in that a detection device, held by a mounting, for determining the wear condition of at least one wear part, in particular the wear part, in particular the comminution tool, is provided, in that the detection device can be moved between a park position and a detection position through the inspection opening by means of an actuator, wherein the detection device is arranged in the detection position at least sectionally inside the crushing chamber and is arranged outside of the crushing chamber in the park position.

The detection device is therefore no longer assigned to the wear part but can be used separately therefrom. In the operating position, the detection device is available inside the crushing chamber and can detect the condition of the wear part. Once the condition of the wear part has been detected, the actuator moves the detection device through the inspection opening into the protected area behind the outer face of the crushing chamber boundary. Preferably, the crushing device can be stopped for a short time to determine the wear of the wear part and then the detection device can be moved into the crushing chamber. This permits the wear part condition to be detected effectively and safely. The risk of damage to the detection device due to the effects of crushed material and/or dust is virtually eliminated.

In particular, the detection device may be an optical measuring device, for instance a measuring device having a laser scanner or a camera, preferably a stereo camera (in particular a 3D camera) or a 2D camera. It is also conceivable that the detection device has one or more laser distance sensors or TOF cameras. Electromagnetic distance measurement methods such as radar sensors or eddy current sensors or capacitive measurement methods are also conceivable. The detection device may also be referred to as a sensor configured to determine the wear state of at least one wear part in the crushing chamber.

According to the disclosure, the wear part may in particular be the comminution device or a part of the comminution device. It is conceivable that the wear part according to the disclosure is a comminution tool or a part of the comminution tool, for instance the crushing tool. It is also conceivable that the wear part according to the disclosure is the crushing chamber lining or a part of the crushing chamber lining. In the context of the disclosure, a wear part can also be any other component that comes into contact with the material to be crushed or comminuted in the crushing chamber.

According to a preferred design variant of the disclosure, provision is made for the mounting to be translatorily, in particular linearly, movable between the detection position and the park position, at least sectionally. Due to the translational, in particular linear, motion, the inspection opening can be designed as having a comparably small opening cross-section. In addition, this renders generating a motion, which can be used to move the mounting sufficiently far into the crushing chamber at a low space requirement and using a simple motion sequence possible.

Preferably provision may be made for the direction of motion of the linear motion of the mounting to be inclined relative to the plane inner or outer face of the crushing chamber boundary in the range from 20°to 70°, preferably from 30°to 60°, particularly preferably from 40°to 50°. In this way, a large optical detection area can be achieved for the detection device, which is at the same time in close proximity to the inner face of the crushing chamber boundary.

A particularly space-saving design can be implemented if provision is made in a first motion for the mounting to be displaced from its park position into an intermediate position, wherein this first motion comprises a swivel motion of the mounting, and in a second motion for the mounting to be displaced from the intermediate position into the detection position, wherein the mounting is moved in a straight line through the inspection opening during the second motion.

If provision is made for the mounting to have or bear a housing, wherein the housing has a mount, in which the detection device is accommodated at least sectionally, then the detection device can be effectively protected against mechanical influences. It is particularly preferable for the housing to have an opening through which the detection device detects the wear condition of the wear part, in particular of the crushing tool, in the detection position. Preferably, the opening is directed downwards in the detection position to prevent damage to the detection device by crushed material falling down inside the crushing chamber.

A simple and robust design results if provision is made for the mounting to be part of an actuating unit of the actuator, wherein preferably provision is made for the actuator to have a cylinder, in which a piston is movably guided, and for the mounting to be coupled to the piston or to the cylinder. In this case, a small number of parts can be achieved in particular if provision is made for the mounting to be integrally coupled to the piston or the cylinder.

A possible variant of the disclosure can be such that the mounting bears or has a closing arrangement, and that the closing arrangement closes the inspection opening in the park position, wherein preferably provision is made for the closing arrangement to be a wear part, which is interchangeably connected to the mounting. The closing arrangement thus prevents crushed material from entering the area on the outer face of the boundary wall during crushing operation, i.e. when the detection device is in the park position. The closing arrangement may be separated from the crushing chamber boundary when the mounting is moved from the park position to the detection position, for instance if it is part of the mounting or is connected to a head piece of the mounting.

A possible variant of the disclosure can be such that a holding device is arranged in the area of the outer face of the crushing chamber boundary, which holding device holds a bearing section spaced apart from the outer face of the crushing chamber boundary, wherein the mounting is coupled in a swiveling manner to the bearing section by means of a guide member, such that the mounting can be swiveled from its park position into the/an intermediate position, and that the actuator can move the detection device from the intermediate position into the detection position.

A robust design can be implemented if provision is made for the holding device to have two bearing sections arranged spaced apart from each other, between which the mounting is held, and for the mounting to be movably connected, preferably swivel connected, to both bearing sections.

A possible variant of the disclosure can be such that the bearing section(s) has/have a link having a linear guide section, which merges into a locking section, and that the mounting is movably guided on the linear guide section in a translatory manner by means of a guide member. This means that the linear guide section can first move the mounting into the intermediate position and secure it there in the locking section. The housing can then be moved translatorily to bring the detection device into the detection position. This makes for a particularly space-saving design. For instance, the mounting can then be held in the park position in close proximity to the outer face of the crushing chamber boundary.

Additionally or alternatively, provision may also be made for the holding device to have a guide, and for the/an actuating unit bearing the detection device to be adjustably guided on the guide in a translatory, in particular rectilinear, manner by means of a guide member. To this end, the actuating unit can be used to move the detection device into the detection position.

A crushing device according to the disclosure can be such that a transmission is provided, which can be used to move the detection device between the detection position and the park position. The transmission can be designed to suit the structural conditions to ensure a suitable motion sequence of the detection device in confined spaces.

In particular, the transmission may gear-up or gear-down the adjustment movement of the actuator to move the detection device.

A particularly simple transmission can be designed as a flat transmission. Preferably, in particular the actuator may be coupled to a lever arm of a toggle lever, a further lever arm of the toggle lever may be swivel connected to a coupler by means of a joint, and the coupler may be directly or indirectly connected to the mounting. Preferably, the toggle lever is secured in position at the crushing chamber boundary in a stationary manner.

The disclosure is explained in greater detail below based on exemplary embodiments shown in the drawings. In the figures,

### BRIEF DESCRIPTION OF THE DRAWINGS

FIG. 1 shows a schematic representation and side view of a material processing plant having a crusher unit,

FIG. 2 shows a perspective view from the left of a schematic representation of a part of the crusher unit of the material processing plant of FIG. 1,

FIG. 3 is a schematic representation of a crushing chamber boundary of the crushing unit having a detection device,

FIG. 4 shows a side view and a sectional view of the arrangement of FIG. 3,

FIG. 5 shows the representation of FIG. 4 in a different operating position,

FIG. 6 shows a further design variant of a detection device for a crushing unit in a park position,

FIG. 7 shows the arrangement of FIG. 6 in a detection position,

FIG. 8 shows a vertical section of the arrangement of FIG. 6,

FIG. 9 shows a vertical section of the arrangement of FIG. 7,

FIG. 10 shows a perspective view of a further design variant of a detection device,

FIG. 11 shows a vertical section of the arrangement of FIG. 10 and in a park position and

FIG. 12 shows the representation of FIG. 11 in a detection position.

### DETAILED DESCRIPTION

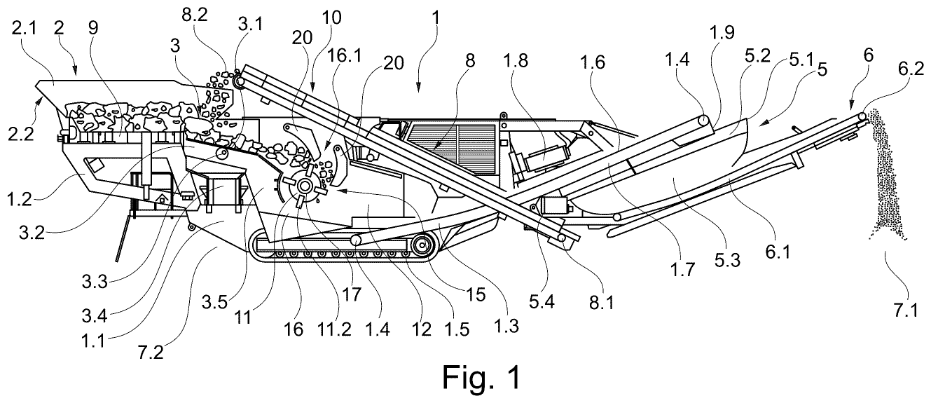

FIG. 1 shows a material processing plant 1 in the form of a crusher having a material processing unit in the form of a crusher unit 10. The material processing plant 1 is designed as a mobile material processing plant 1 and therefore has travel units 1.5. However, it is also conceivable that the material processing plant 1 is a stationary material processing plant 1.

The material processing plant 1 has a chassis 1.1 that bears the machine components or at least a part of the machine components. At its rear end, the chassis 1.1 can preferably have a cantilever 1.2. A material feed area is formed in the area of the cantilever 1.2.

The material feed area may comprise a feed hopper 2 and a material feed device 9.

The feed hopper 2 may be formed at least in part by hopper walls 2.1 extending in the direction of the longitudinal extent of the material processing plant 1 and a rear wall 2.2 extending transversely to the longitudinal extent. The feed hopper 2 leads to the material feed device 9.

As shown in this exemplary embodiment, the material feed device 9 may comprise a conveyor chute that can be driven by means of a vibratory drive. The feed hopper 2 can be used to feed material to be comminuted into the material processing plant 1, for instance using a wheel loader, and to feed it onto the conveyor chute.

As the drawing shows, it may preferable for the material to be comminuted to pass from the conveyor chute into the area of a screen unit 3. This screen unit 3 may also be referred to as a pre-screening arrangement. At least one screen deck 3.1, 3.2 is disposed in the area of the screen unit 3. In this exemplary embodiment two screen decks 3.1, 3.2 are used. A system configuration in which no pre-screen arrangement is used is also conceivable.

A partial fraction of the material to be comminuted is screened out at the upper screen deck 3.1. This partial fraction already has a sufficient particle size that it no longer needs to be comminuted in the material processing plant 1. In this respect, this screened out partial fraction can be routed past the crusher unit 10 through a bypass channel 3.5.

If a second screen deck 3.2 is used in the screen unit 3, a further fine particle fraction can be screened out from the partial fraction that accumulates below the screen deck 3.1. This fine particle fraction can be routed to a lateral discharge conveyor 3.4 below the screen deck 3.2. The fine particle fraction is diverted from the lateral discharge conveyor 3.4 and conveyed to a rock pile 7.2 located laterally of the machine.

As FIG. 1 illustrates, the screen unit 3 may be a vibrating screen having a screen drive 3.3. The screen drive 3.3 causes the screen deck 3.1 and/or the screen deck 3.2 to vibrate. Owing to the inclined arrangement of the screen decks 3.1, 3.2 and in conjunction with the vibration motions, material on the screen decks 3.1, 3.2 is transported towards the crusher unit 10 or towards the bypass channel 3.5.

The material to be comminuted and arriving from the screen deck 3.1 is routed to the crusher unit 10, as shown in FIG. 1.

The crusher unit 10 can, for instance, take the form of an impact crusher unit, in particular a rotary impact crusher unit, a jaw crusher unit, a cone crusher unit or a gyratory crusher unit. The crusher unit 10 has a comminution device 11.

If a rotary impact crusher unit is used, as in FIG. 1, it has as comminution device 11, for instance, an impact rotor, which is driven by an internal combustion engine 12. In FIG. 1, the axis of rotation 17 of the impact rotor is horizontal in the direction of the image depth. The impact rotor is housed in a crushing chamber 16.1.

If a jaw crushing unit is used, the comminution device 11 has two opposing crushing jaws that enclose a converging crushing shaft between them, resulting in a crushing gap. At least one of the crushing jaws may be driven, for instance by the internal combustion engine 12, to crush the material to be crushed filled in the converging crushing gap.

For instance, the outer circumference of the impact rotor can be fitted with comminution tools 11.2, which are designed as impact bars in this case. Opposite from the impact rotor, for instance, wall elements may be disposed, preferably in the form of impact rockers 20. When the impact rotor is rotating, the impact bars throw the material to be comminuted outwards. In so doing, this material hits the impact rockers 20 and is comminuted due to the high kinetic energy. When the material to be comminuted is of sufficient particle size to allow the material particles to pass through a crushing gap 15 between the impact rockers 20 and the radially outer ends of the impact bars, the comminuted material exits the crusher unit 10 through the crusher outlet 16.

It is conceivable that in the area of the crusher outlet 16, the comminuted material routed from the crusher unit 10 is combined with the material routed from the bypass channel 3.5 and transferred onto a belt conveyor 1.3. The belt conveyor 1.3 can be used to convey the material out of the working area of the crusher unit 10.

As shown in the drawings, the belt conveyor 1.3 may comprise an endless circulating conveyor belt having a slack side 1.6 and a tight side 1.7. The slack side 1.6 is used to catch and transport away the crushed material falling from the crusher outlet 16 of the crusher unit 10. At the belt ends, deflection rollers 1.4 can be used to deflect the conveyor belt from the slack side 1.6 to the tight side 1.7 and vice versa. Guides, in particular support rollers, can be provided in the area between the deflection rollers 1.4 to change the direction of conveyance of the conveyor belt, to shape the conveyor belt in a certain way and/or to support the conveyor belt.

The belt conveyor 1.3 has a belt drive, which can be used to drive the belt conveyor 1.3. The belt drive can preferably be disposed at the discharge end 1.9 or in the area of the discharge end 1.9 of the belt conveyor 1.3.

The belt conveyor 1.3 can be connected, for instance by means of the belt drive, to a control device by means of a control line.

One or more further belt conveyors 6 and/or a return conveyor 8 may be used, which in principle have the same design as the belt conveyor 1.3. In this respect, reference can be made to the above statements.

A magnet 1.8, in particular an electric magnet, can be disposed above the slack side 1.6 in the area between the feed end and the discharge end 1.9. The magnet 1.8 can be used to lift iron parts from the broken material and move them out of the conveying area of the belt conveyor 1.3.

A re-screening device 5 can be disposed downstream of the belt conveyor 1.3. The crusher unit 5 has a screen housing 5.1, in which at least one screen deck 5.2 is mounted. Below the screen deck 5.2, a housing base 5.3 is formed, which is used as a collection space for the material screened out at the screen deck 5.2.

An opening in the lower housing part 5.3 establishes a spatial connection to the further belt conveyor 6. Here, the further belt conveyor 6 forms its feed area 6.1, wherein the screened material in the feed area 6.1 is directed onto the slack side of the further belt conveyor 6. The further belt conveyor 6 conveys the screened material towards its discharge end 6.2. From there, the screened material is transferred to a rock pile 7.1.

The material not screened out at the screen deck 5.2 of the re-screening device 5 is conveyed from the screen deck 5.2 onto a branch belt 5.4. The branch belt 5.4 can also be designed as a belt conveyor, i.e., reference can be made to the explanations given above with respect to the belt conveyor 1.3. In FIG. 1, the transport direction of the branch belt 5.4 extends in the direction of the image depth.

At its discharge end, the branch belt 5.4 transfers the un-screened material, also referred to as oversize material, to a feed area 8.1 of the return conveyor 8. The return conveyor 8, which may be a belt conveyor, conveys the oversize material towards the feed hopper 2. At its discharge end 8.2, the return conveyor 8 transfers the oversize material into the material flow, in particular into the material feed area. The oversize material can therefore be returned to the crusher unit 10 and crushed to the desired particle size.

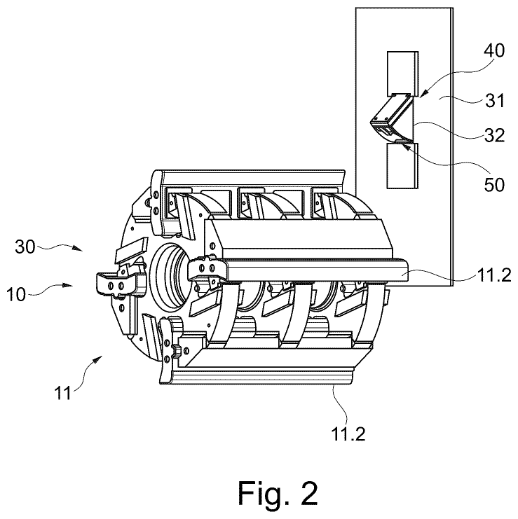

FIG. 2 shows the comminution device 11 with its comminution tools 11.2. These are interchangeably held on the rotor of the comminution device 11. As the representation illustrates, the comminution device 11 is arranged in the crushing chamber 30. The crushing chamber 30 is closed off from the surroundings, at least sectionally, by means of a crushing chamber boundary 31.

FIG. 2 only shows a part of a crushing chamber boundary 31 by way of example. As this representation illustrates, the crushing chamber boundary 31 can be a part of a wall, which has an inner face 31.2 facing the crushing chamber 30 and an outer face 31.1 facing away from the crushing chamber 30. The crushing chamber boundary 31 has an inspection opening 32. The inspection opening 32 can be formed by an aperture that is excluded or recessed from the crushing chamber boundary 31.

In this exemplary embodiment, the inspection opening 32 has the form of a rectangular aperture, which is delimited by opposing horizontal and opposing vertical edge sections.

As the illustrations show, a monitoring device having a detection device 50 is arranged in the area of the crushing chamber boundary 31. FIG. 2 shows the detection device 50 in a detection position. In this detection position, the detection device 50 is arranged at least partially in the crushing chamber 30. The detection device 50 can then detect the state of wear of at least one of the comminution tools 11.2 or any other wear part in the crushing chamber 30.

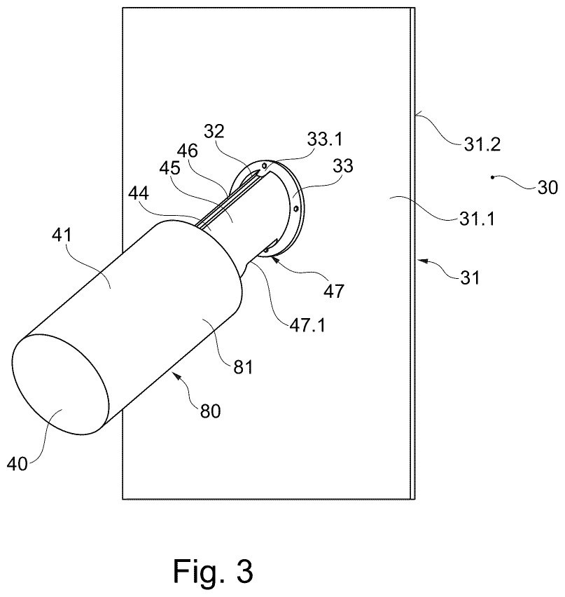

FIG. 3 shows the detection device 50 in a park position. In this park position, the detection device 50 is moved out of the crushing chamber 30 and held in the area behind the outer face 31 of the crushing chamber boundary 31.

The detection device 50 can be moved between the park position and the detection position, in particular it can be moved translationally, preferably linearly.

FIG. 3 shows a further design variant of the disclosure. As this embodiment illustrates, the inspection opening 32 may be formed by an aperture in the crushing chamber boundary 31, which is preferably cut out of the crushing chamber boundary 31 as a circular section. A guide element 33 can be arranged in the area of the inspection opening 32, which is used to guide the adjustment movement of the detection device 50 between the park position and the detection position. Preferably, the guide element 33 is arranged around the inspection opening 32 and has, for instance, at least one guide neck 33.1.

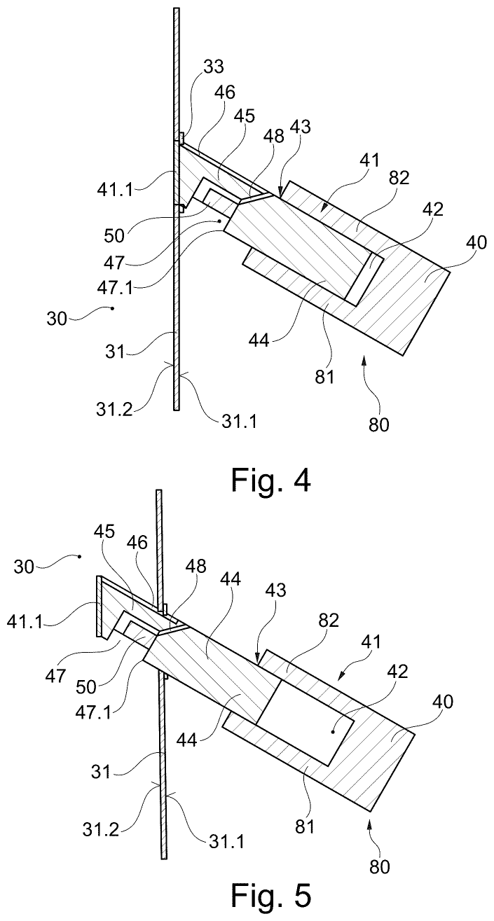

FIGS. 4 and 5 show the structure of the monitoring device in more detail. As these figures illustrate, the monitoring device has a mounting 40, which bears the detection device 50. For this purpose, the mounting 40 can have a housing 41, on or in which an actuating unit 44 is movably guided. The actuating unit 44 can be moved between the park position shown in FIG. 4 and the detection position shown in FIG. 5.

As the illustrations show, the adjustment movement of the actuating unit 44 is linear. Preferably, the angle of the direction of motion of the actuating unit 44 to the plane formed by the crushing chamber boundary 31 is less than or equal to 90°. In this exemplary embodiment, the angle between the direction of motion of the actuating unit 44 and the plane formed by the crushing chamber boundary 31 is selected in the range from 20°to 70°, preferably in the range from 40°to 60°. In the special exemplary embodiment shown in FIGS. 4 and 5, the angle is 45°.

The actuating unit 44 is preferably moved from the park position to the detection position in an upward direction of actuation, i.e. against the direction of gravity.

It may be that the actuating unit 44 has a head 45 having a mount 47. The detection device 50 is accommodated in this mount 47. The detection device 50 can be an optical detection device, for instance a camera. The mount 47 has an opening 47.1, which opens the mount 47 downwards against the direction of gravity, as shown in FIG. 5.

A cable duct 48 is incorporated into the head 45 and is used to accommodate a cable. This cable 48 can be used to electrically connect the detection device 50 to an evaluation circuit (not shown). The cable duct 48 is arranged in such a way that the cable can be guided in a protected manner into the area behind the outer face 31.1 of the crushing chamber boundary 31 in the detection position according to FIG. 5.

FIGS. 4 and 5 show that the guide neck 33.1 of the guide element 33 interacts with an anti-rotation lock 46 of the actuating unit 44. In particular, the anti-rotation lock 46 may be designed as a groove, which is incorporated into the actuating unit 44 and extends in the direction of actuation of the actuating unit 44. The guide neck 33.1 engages with this groove to prevent the actuating unit 44 from turning.

Preferably, the housing 41 is part of an actuator 80, namely a piston-cylinder unit. The housing 41 may form a cylinder 82. An actuating medium, in particular a hydraulic fluid, is held in the chamber 42 of the housing 41.

Preferably, the actuating unit 44 may be part of the actuator 80, and may in particular form the piston of the piston-cylinder unit.

If, starting from the park position shown in FIG. 4, the chamber 42 the actuating medium is pressurized, the actuating unit 44 is moved through the cylinder opening 43 such that the detection device 50 is guided linearly through the inspection opening 32 into the crushing chamber 30. If the actuating medium is drained from the chamber 42, the actuating unit 44 returns into the chamber 42, which can also be supported by a spring (not shown), for instance.

Preferably, as the drawings illustrate, the actuating unit 44 comprises or bears a closing arrangement 41.1. In this exemplary embodiment, the closing arrangement 41.1 is designed as a separate component that is interchangeably connected to the head 45 of the actuating unit 44. The locking arrangement 44.1 may be designed integrally with the head 45. In the park position shown in FIG. 4, the actuating unit 44.1 at least partially closes the inspection opening 32. In particular, the closing arrangement 41.1 may have a flat outer face facing the crushing chamber 30, which outer face is preferably aligned with the inner face 31.2 of the crushing chamber boundary 31 in the park position. The closing arrangement 41.1 may also be referred to as an inspection closure 41.1.

The closing arrangement 41.1 may be moved by the actuating unit 44 in the detection position. Preferably, the closing arrangement 44.1 is then held at a distance from the inner face 31.2 of the crushing chamber boundary 31, as illustrated in FIG. 5.

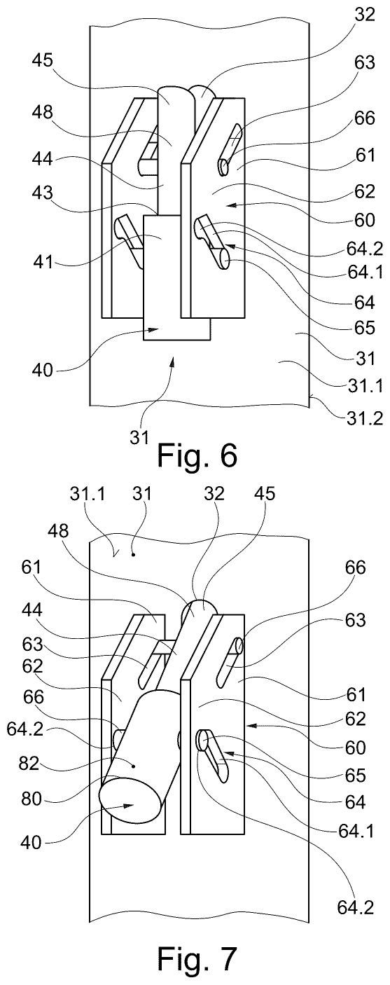

FIGS. 6 to 9 illustrate a further embodiment of the disclosure. The illustrations show that a holding device 60 holds the monitoring device on the outer face 31.1 of the crushing chamber boundary 31. The holding device 60 has two bearing sections 62, which are preferably each formed by a plate-shaped support part. A fastening section 61 can be used to connect this plate-shaped support part to the outer face 31.1 of the crushing chamber boundary 31. The holding device 60 may also be referred to as a holder 60 or as a bracket 60.

Preferably, the bearing sections 62 are arranged spaced apart from each other. An arrangement is held between the two bearing sections 62, which arrangement is essentially equal to the arrangement of FIGS. 3 to 5, i.e., reference can be made to the above explanations. The differences are therefore discussed below.

As the illustrations show, the actuating unit 44 has guide members 66 on opposite ends. These guide members 66 are guided linearly in guides 63 of the holding device 60.

The holding device 60 may also have at least one link 64, on which the mounting 40 is movably guided. In this exemplary embodiment, a link 64 is provided on each of the two bearing sections 62. The link 64 has an area that forms a linear guide 64.1. This linear guide 64.1 merges into a locking section 64.2 facing away from the outer face 31.1 of the crushing chamber boundary 31. As FIG. 6 clearly shows, the locking section 64.2 can be designed as a lateral extension of the linear guide 64.1. Guide members 65 are used to guide the mounting 40 in the two links 64.

To move the detection device 50 from the park position shown in FIG. 6 to the detection position shown in FIG. 7, the mounting 40 is first moved in the link 64 by means of the guide members 65 until the guide members 65 come to rest in the locking sections 64.2. At the same time, the guide elements 66 in the guides 63 also move a little, for the mounting 40 to perform a swivel motion and be brought into an intermediate position. At the end of this adjustment movement, the head 45 of the actuating unit 44 is opposite from the inspection opening 32, but is still located in the area of the outer face 31.1 of the crushing chamber boundary 31.

The actuating unit 44 can then be moved linearly such that the detection device 50 moves through the inspection opening 32 into the crushing chamber 30. The guide members 66 in the guides 63 linearly guide the actuating unit 44 in its motion.

Once the wear condition of the comminution tools 11.2 has been determined, the actuating unit 44 can be moved linearly through the inspection opening 32 to the intermediate position and the mounting 40 can then be moved to the park position shown in FIG. 6.

It is conceivable that a closing arrangement 41.1 is also provided, which is used to close the inspection opening 32. This closing arrangement 41.1 can have a closing part, which is connected to the crushing chamber boundary 31 in a displaceable and/or swiveling manner.

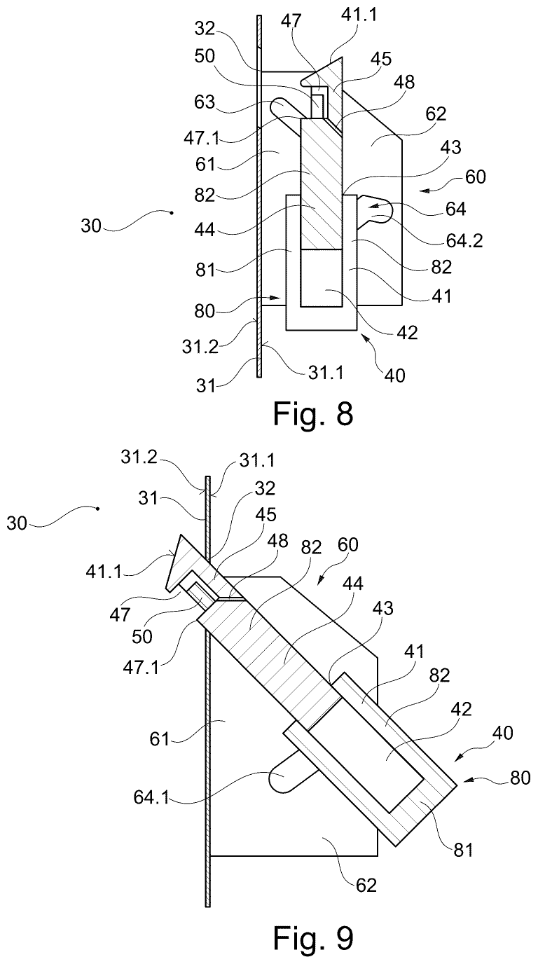

FIGS. 8 and 9 show sectional views of the individual operating positions of FIGS. 6 and 7. As these figures illustrate, the mounting 40 can again form a housing 41 in the form of a cylinder 81 of an actuator 80. The actuating unit 44 can again be a piston rod 82, as shown in FIGS. 3 to 5.

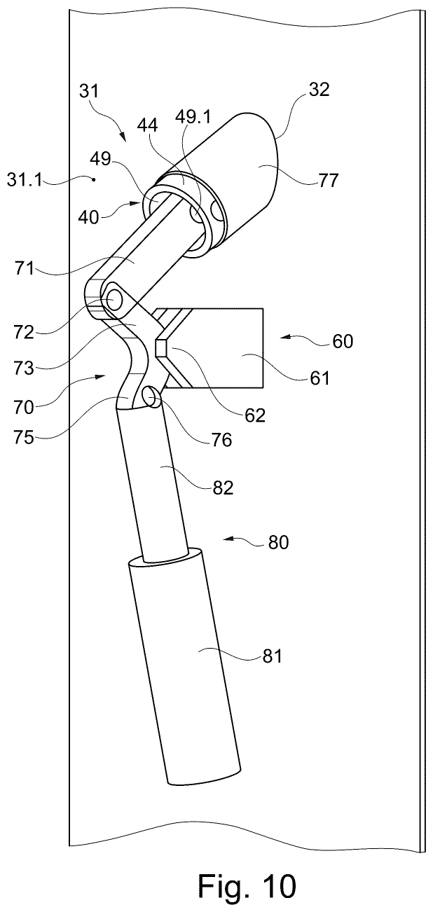

FIGS. 10 to 12 show a further exemplary embodiment of the disclosure. FIG. 10 illustrates that an actuator 80 is provided in the form of a cylinder-piston unit. It has a cylinder 81. A piston is movably guided in the cylinder 81. The piston is coupled to a piston rod 82.

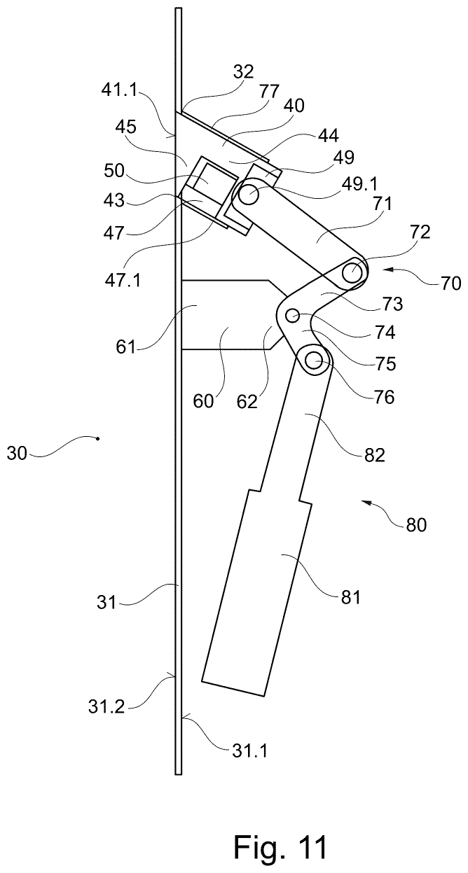

The actuator 80 can move the mounting 40 via a transmission 70. The mounting 40 again bears the detection device 50, as shown for instance in FIG. 11.

The transmission 70 can preferably be designed as a flat transmission. The transmission 70 may have a toggle lever, which has two lever arms 73, 75 at an angle to each other. The toggle lever is mounted in position, preferably attached to the outer face 31.1 of the crushing chamber boundary 31 by means of a holding device 60. The holding device 60 can have two bearing sections 62, which are arranged spaced apart from each other. The toggle lever is swivel mounted between the two bearing sections 62. For this purpose, the toggle lever is swivel connected to the holding device 60 by means of a support bearing 74. The actuator 80 is coupled to the first lever arm 73, preferably by means of the piston rod 82, via a joint 76, in a swiveling manner. The second lever arm 63 is swivel connected to a coupling 71 via a joint 72. The coupler 71 bears the mounting 40 at its end facing away from the joint 72. Preferably, the mounting has a coupling mount 49 having a coupling joint 49.1 to which the coupling 71 is connected.

FIG. 11 illustrates that the coupler mount 49 can be designed as a recess in the mounting 40.

The mounting 40 can again be designed in such a way that it forms a mount 47 on a head 45. As in the previous exemplary embodiments, the mount 45 may again have an opening 47.1, through which, in the detection position, the detection device 50 can detect the wear state of at least one comminution tool 11.2. The head 45 of the actuating unit 44 again forms a closing arrangement 41.1, which, as the figures show, can be designed integrally with the head 45.

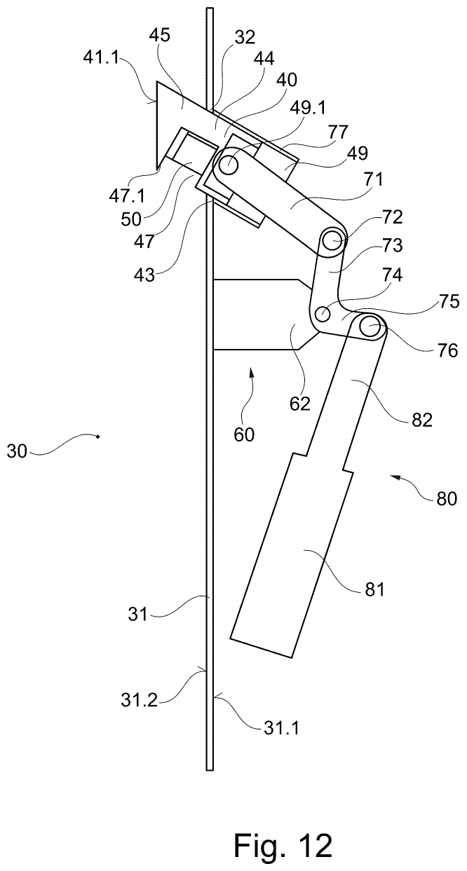

The actuating unit 44 is linearly movably guided in a linear guide 77 such that it can be moved in a straight line between the park position shown in FIG. 11 and the detection position shown in FIG. 12. Preferably, the linear guide 77 is designed as a sleeve, which protrudes in the area of the outer face 31.1 of the crushing chamber boundary 31 and in which the mounting 40 is accommodated.

If, starting from the park position shown in FIG. 11, the actuator 80, whose cylinder 81 is secured in position opposite from the crushing chamber boundary 31, is actuated, the piston rod 82 extends from the cylinder 81 and swivels the toggle lever. As a result of this swivel motion, the coupler 71 is also moved. As a result of this movement, the actuating unit 44 is displaced in the linear guide 77 to move the detection device 50 into the crushing chamber 30. Once the wear condition of the at least one comminution tool 11.2 has been detected, the mounting 40 is returned in the opposite direction until the detection device 50 comes to rest in the park position shown in FIG. 11. At the same time, the closing arrangement 41.1 of the actuating unit 44 also closes the inspection opening 32 (see FIG. 11).

In the explanations above, the mode of operation of the disclosure was explained with reference to the detection of the wear condition of the comminution tool 11.2. However, the disclosure is not limited to this; rather, the wear condition of any other wear part in the crushing chamber may additionally or alternatively be detected by the detection device 50.

1-14. (canceled)

15. A crushing device for crushing mineral material, comprising:
at least one crushing chamber boundary delimiting a crushing chamber, the at least one crushing chamber boundary including an inner face facing the crushing chamber and an outer face facing away from the crushing chamber, the crushing chamber boundary including an inspection opening;
a comminution device received in the crushing chamber, the comminution device including at least one comminution tool;
a sensor configured to determine a state of wear of at least one wear part in the crushing chamber; and
a mounting configured to hold the sensor;
wherein the sensor is configured to be moved at least partially through the inspection opening between a park position wherein the sensor is at least partially outside of the crushing chamber and a detection position wherein the sensor is at least partially inside of the crushing chamber.

16. The crushing device of claim 15, wherein:
the mounting is configured to be moved at least partially in a linear motion to move the mounting between a detection position and a park position of the mounting corresponding to the detection position and the park position, respectively, of the sensor.

17. The crushing device of claim 16, wherein:
the mounting is configured such that a direction of motion of the linear motion of the mounting is inclined relative to a plane inner or outer face of the crushing chamber boundary in a range from 20°to 70°.

18. The crushing device of claim 16, wherein:
the mounting is configured such that a direction of motion of the linear motion of the mounting is inclined relative to a plane inner or outer face of the crushing chamber boundary in a range from 30°to 60°.

19. The crushing device of claim 16, wherein:
the mounting is configured such that a direction of motion of the linear motion of the mounting is inclined relative to a plane inner or outer face of the crushing chamber boundary in a range from 40°to 50°.

20: The crushing device of claim 16, wherein:
the mounting is configured such that a movement of the mounting from the park position to the detection position includes a first motion in which the mounting is moved in a swivel motion from the park position to an intermediate position and a second motion wherein the mounting is displaced from the intermediate position to the detection position, wherein the mounting is moved in a straight line through the inspection opening during the second motion.

21. The crushing device of claim 15, wherein:
the mounting includes a housing and the sensor is at least partially received in the housing.

22. The crushing device of claim 15, further comprising:
an actuator including a cylinder and a piston movably guided in the cylinder, the mounting being coupled to the piston or the cylinder.

23. The crushing device of claim 15, wherein:
the mounting includes an inspection closure configured to close the inspection opening when the sensor is in the park position.

24. The crushing device of claim 23, wherein:
the inspection closure is a wear part interchangeably connected to the mounting.

25. The crushing device of claim 15, further comprising:
a bracket attached to the outer face of the crushing chamber boundary, the bracket including a bearing section spaced apart from the outer face of the crushing chamber boundary, wherein the mounting is coupled in a swiveling manner to the bearing section of the bracket by a guide member, such that the mounting can be swiveled to move the sensor from the park position to an intermediate position; and
an actuator configured to move the sensor from the intermediate position to the detection position.

26. The crushing device of claim 25, wherein:
the bracket includes two of the bearing sections spaced apart from each other, and the mounting is held between the two bearing sections, such that the mounting is swivel connected to both bearing sections.

27. The crushing device of claim 25, wherein:
the bearing section includes a linear guide section which merges into a locking section; and
the mounting includes a guide member movably guided in the linear guide section in a translatory manner.

28. The crushing device of claim 25, wherein:
the bearing section includes a guide section; and
the actuator includes a guide member movably guided in the guide section in a linear manner.

29. The crushing device of claim 15, further comprising:
a transmission configured to move the sensor between the detection position and the park position.

30. The crushing device of claim 29, further comprising:
an actuator;
wherein the transmission is configured to gear-up or gear-down a movement of the actuator to move the sensor.

31. The crushing device of claim 30, wherein:
the transmission includes a toggle leaver including a first lever arm and a second lever arm;
the actuator is coupled to the first lever arm;
the crushing device further includes a coupler swivel connected to the second lever arm, the coupler being directly or indirectly connected to the mounting.
